(19) United States
(12) Patent Application Publication
(10) Pub. No.: US 2023/0011635 A1
(43) Pub. Date: Jan. 12, 2023

(54) METHOD OF FACE EXPRESSION RECOGNITION

(71) Applicant: VIETTEL GROUP, Ha Noi City (VN)

(72) Inventors: Thi Hanh Vu, Hai Phong City (VN); Quang Nhat Vo, Bien Hoa City (VN); Manh Quy Nguyen, Ha Noi City (VN); Ngoc Duong Hoang, Hiep Hoa District (VN); Khac Duy Ngoc Nguyen, Ha Noi City (VN)

(73) Assignee: VIETTEL GROUP, Ha Noi City (VN)

(21) Appl. No.: 17/854,682

(22) Filed: Jun. 30, 2022

(30) Foreign Application Priority Data
Jul. 9, 2021 (VN) 1-2021-04219

(51) Int. Cl. G06V 40/16; G06V 10/82; G06V 10/774; G06N 3/04

(52) U.S. Cl. CPC G06V 40/176; G06V 40/172; G06V 10/82; G06V 10/774; G06N 3/0454

(57) ABSTRACT

The present invention provides a method of facial expression recognition including 3 steps: step 1: collecting facial expression data, which contributes to solve the problem of lacking data, disparate and bias data, that cause the overfitting problem when training the deep learning model; step 2: designing a new deep learning network that able to focus on special regions of the face to extract and learn the important features of facial expressions by intergating ensemble attention modules into basic deep network architecture like ResNet; step 3: training the ensemble attention deep learning model in step 2 on the collected dataset in step 1, using the combination of two loss functions including ArcFace and Softmax to reduce the overfitting problem.

### BACKGROUND OF THE INVENTION

### Technical field of the invention

The disclosure mentions a method of facial expression recognition from images. Specifically, the method proposes to use an ensemble attention deep learning model. It can be widely applied in the fields of customer psychoanalysis, criminal psychoanalysis, mental and emotional disorders detection, and medical therapy.

### Technical Status of the Invention

Facial expression is one of the most effective and popular ways that people can show their feelings and thoughts. Recently, the research on automatic facial expression recognition has been raising due to it's great ability to apply in many fields such as customer psychoanalysis, medical therapy, human-machine communication, etc. In recent years, based on the accelerated growth of artificial intelligence, there are several facial expression recognition methods that have been proposed and have achieved relatively good results on some popular datasets such as FER+, AffectNet. Although these deep learning models have obtained the state-of-the-art, the capacity to apply these models to the real world is somewhat restricted, mainly due to the following reasons:

First, the datasets using for training are relatively small, and they are comparatively different to real life situations. Especially, the data of Asian face and Vietnamese face images is rarer than others. The deep learning models, which are trained on these datasets, potentially suffer from overfitting problem. Therefore, they have difficultly to achieve better prediction on other datasets or in the real life applications.

Secondly, the collected datasets weren't able to cover all special cases, for example, partially covered faces, slanted viewing faces, and variable brightness faces. Consequently, it's necessary to study the deep learning networks that are better able to focus on special parts of the face to extract and learn the important features of facial expressions.

### BRIEF SUMMARY OF THE INVENTION

The invention provides a facial expression recognition method using ensemble attention deep learning model to reduce those above restrictions. It aims to improve the facial expression recognition accuracy, especially focusing on Vietnamese face dataset to apply effectively to the production in Vietnam.

Specifically, the proposed method includes:

Step 1: Collecting facial expression data. It aims to contribute a rich and diverse facial expression dataset which added more Asian face and Vietnamese face images to train the deep learning model.

Step 2: Designing a new deep learning network (model) which is integrated ensemble attention modules. These modules are able to support the network to extract more valuable features of facial expression and learn to classify them.

Step 3: Training the ensemble attention deep learning model using the combination of two loss functions including ArcFace and Softmax. The final loss function is the summation of two loss funtions with an alpha parameter (Equation 2) as a weight of the combination. The alpha parameter is updated automatically based on the learning rate in the training process. The ArcFace loss function is proposed to use in this invention to reduce overfiting problem while training face data.

### BRIEF DESCRIPTION OF THE SEVERAL VIEWS OF THE DRAWINGS

FIG. 1 is the architecture diagram of the deep learning model that is integrated ensemble attention modules to use for facial expression recognition.

FIG. 2 is a flow diagram of training the ensemble attention deep learning model using a combination of two loss functions: ArcFace and Softmax.

### DETAILED DESCRIPTION OF THE INVENTION

The detailed description of the invention is interpreted in connection with the drawings, which are intended to illustrate variations of the invention without limiting the scope of the patent.

In this description of the invention, the terms of “RetinaFace”, “ResNet”, “ArcFace”, “Softmax”, “FER+”, and “AffectNet” are proper nouns, which are the name of the model or the dataset.

Method of facial expression recognition includes the following steps:

Step 1: Collecting facial expression data.

The purpose of this step is enhancing the facial expression data since the avaiable datasets are relatively small and comparatively different with real life situations, that makes the deep learning models have to face up with the overfitting problem. The characteristics of our collected dataset includes the richness and diversity, covering many special cases in reality, and reasonable distribution according to the following aspects:
Expressions: happy, sad, angry, surprise, disgust, fear, neutral.
Genders: male, female.
Ages: children, teenagers, adults, the elderly.
Geography: Europeans, Asians, Vietnamese.
Face position: frontal, left or right side with the angle fluctuating from 0° to

90°, face up or down with angle fluctuating from 0° to 45°.

From these raw data, the face detection and alignment from the original images is performed by the RetinaFace model. Then, the detected faces are cropped, normalized and aligned. Next, they are fed into the proposed ensemble attention deep learning model for further processing in the following steps.

Step 2: Designing a new deep learning network (model) for facial expresion recognition.

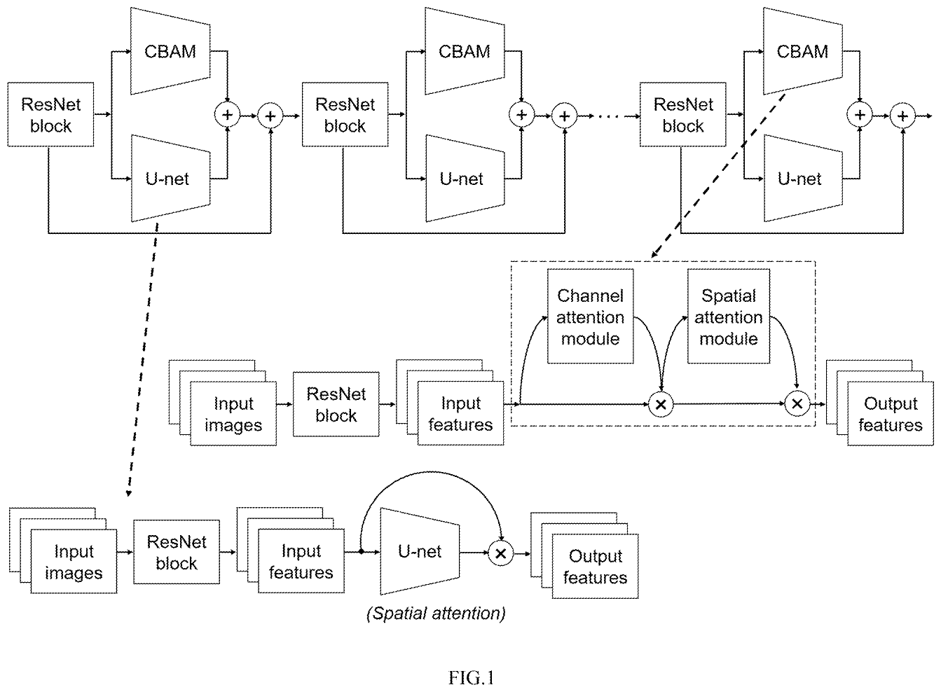

FIG. 1 describes the architecture of the proposed deep learning model that is integrated ensemble attention modules to use for facial expression recognition. The network is designed based on ResNet blocks, and the attention modules are intergated into these ResNet blocks including CBAM (Convolutional Block Attention Module) and U-net. These modules attempt to extract more valuable features based on channel attention and spatial attention mechanisms. In other words, they orientate the network to focus on the important weights during the training process.

Firstly, the CBAM module is made up of two successively smaller modules: the channel attention module and the spatial attention module. The input of the channel attention module is the features extracted from the ResNet block. This ResNet block can consist of two layers (used in ResNet 18 and 34) or three layers (used in ResNet 50, 101, 152). These input features are pooled into two one-dimensional vectors, and then are fed into a deep neural network. The output of this module is a one-dimensional vector, which then is multiplied by the input features, and forwarded to the spatial attention module. In the spatial attention module, the input features are merged into two two-dimensional matrices and fed into the convolutional layers. Similarly, the output of this spatial attention module is again multiplied by the input features, and forwarded to the next ResNet block. Secondly, the U-net module consists of an encoder and a decoder. The purpose of the U-net module is similar to CBAM, to help the network concentrate on spatial features and perform more accurate expression classification.

Thirdly, the outputs of the CBAM and U-net modules are combined to generate a final feature set. To avoid these attention modules removing useful features, the input features from the ResNet block is added to the generated feature set to produce the final features and passed to the next block. The output features of CBAM and U-net have the same size as the input features. The ensemble attention modules and the ResNet blocks can be serialized N times (recommend with N=4 or 5) to build a more deeply attention network architecture.

Step 3: Training the ensemble attention deep learning model using the combination of two loss functions includes ArcFace and Softmax.

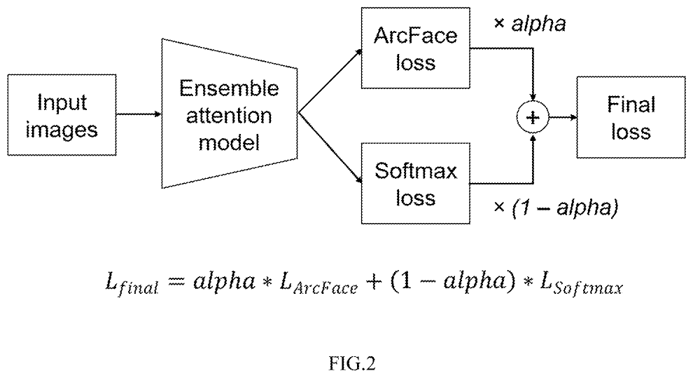

FIG. 2 shows this training process.

This step aims to use these two loss functions for training the model to reduce overfitting problem. The Softmax loss function is used popularly to train many other deep learning models; however, it has a disadvantage of not solving the overfitting problem. This invention proposes to use ArcFace loss function together with Softmax loss function. Despite of the effectively applying to face recognition of Arcface loss function, it wasn't noticed to use for facial expression recognition. Arcface loss function potentially restricts the overfitting problem while training the model, and ables to classify facial expressions better. It was proved to enhance the classification results on learned features, and help the training process more stable. The Arcface loss function is defined as folow (this is an available formula used in face recognition research; nevertheless, the formula is given here to show how to apply in this invention):

$${L}_{Arc Face} = - \frac{1}{N} {\sum }_{i = 1}^{N} log \frac{{e}^{s ( cos ( {θ}_{y i} + m ) )}}{{e}^{s ( cos ( {θ}_{yi} + m ) )} + {\sum }_{j = 1 , j \neq yi}^{n} {e}^{scos {θ}_{j}}} \qquad ( 1 )$$

Where N is the number of trained images; s and m are two constants used to change the magnitude of the value of the features, and increase the ability to classify the features; θ_{y1} is the angle between the extracted features and the weights of deep learning network. The learning objective is to maximize the angular distance θ for feature discrimination of different facial expressions. The final loss function is the summation of two loss funtions with an alpha parameter in the equation (2) as a weight of the combination. This is a new formula that first time proposes to use in this invention:

L_{final}=alpha*L_{ArcFace}+(1−alpha)*L_{Softmax} (2)

The alpha parameter is updated automatically based on the learning rate. In the earlier phase of training, while the learning rate is high (recommend with learning rate=0.01), alpha is set to a high value (e.g., alpha=0.9) to prioritize the ArcFace loss function and reduce overfiting. After the model's training process is more stable, the alpha is gradually decreased to classify the facial expression based on Softmax loss. The deceasing of the learning rate is decided based on the accuracy on the validation dataset. If after 10 epochs, the accuracy on the validation dataset doesn't increase, the learning rate will be reduced to 1/10 of the earlier learning rate. The corresponding decreasing rate of alpha is decided based on the training experiment, and depending on the train dataset.

At the end of step 3, the ensemble attention deep learning model has been trained and used to predict facial expressions from images. This model can be applied in some software or computer programs for image processing to build related products. Basically, the input of the software can be the camera RTSP (Real Time Streaming Protocol) link or offline video, and the output is the facial expression analysis results of the people appeared in those camera or video. For example, person A has a happy expression, person B has an angry expression, etc.

Although the above descriptions contain many specifics, they are not intended to be a limitation of the embodiment of the invention, but are intended only to illustrate some preferred execution options.

1. Method of face facial expression recognition comprising:
Step 1: Collecting face expression data,
a facial expression dataset is collected with the purpose of training a deep learning model effectively, characteristics the collected facial expression dataset includes a richness and diversity, covering many special cases in reality, and distribution according to the following aspects:
Expressions: happy, sad, angry, surprise, disgust, fear, neutral,
Genders: male, female,
Ages: children, teenagers, adults, the elderly,
Geography: Europeans, Asians, Vietnamese,
Face position: frontal, left or right side with angle fluctuating from 0° to 90°, face up or down with angle fluctuating from 0° to 45°,
Step 2: Designing a new deep learning network (model) for facial expression recognition;
the new deep learning network architecture is built based on basic network (ResNet blocks) and is integrated ensemble attention modules. These modules aim to support the new deep learning network to extract more valuable features of facial expression and learn to classify them;
Step 3: Training the ensemble attention deep learning model using a combination of two loss functions including ArcFace and Softmax,
a final loss function is a summation of two loss funtions with an alpha parameter as a weight of the combination, The formula is:
L_{final}=alpha*L_{ArcFace}+(1−alpha)*L_{Softmax}
In which, the alpha parameter is updated automatically based on a learning rate, In an earlier phase of training, alpha is set to a high value to prioritize the ArcFace loss function and reduce overfiting, After the model's training process is more stable, the alpha is gradually decreased to classify the facial expression based on Softmax loss.

2. The method of facial expression recognition according claim 1, further comprising:
In step 2: The network is designed based on ResNet blocks, and the attention modules are intergated into these ResNet blocks including a CBAM (Convolutional Block Attention Module) and an U-net, These modules attempt to extract more valuable features based on channel attention and spatial attention mechanisms, they orientate the network to attent and learn focus on important weights during training process, in that:
The CBAM module is made up of two successively smaller modules: a channel attention module and a spatial attention module, in that:
The input of the channel attention module is the features extracted from the ResNet block, This ResNet block can consist of two layers (used in ResNet 18 and 34) or three layers (used in ResNet 50, 101, 152), These input features are pooled into two one-dimensional vectors and then are fed into a deep neural network, The output of this module is a one-dimensional vector, which then is multiplied by the input features, and forwarded to the spatial attention module,
In the spatial attention module, the input features are merged into two two-dimensional matrices and put fed into the convolutional layers, the output of this spatial attention module is again multiplied by the input features, and forwarded to the next ResNet block,
The U-net module consists of an encoder and a decoder, The purpose of the U-net module is similar to CBAM, to help the network concentrate on spatial features and perform more accurate expression classification,
The outputs of the CBAM and U-net modules are combined to generate a final feature set, To avoid these attention modules removing useful features, the input features from the ResNet block is added to the generated feature set to produce the final features and passed to the next block, The output features of CBAM and U-net have the same size as the input features, The ensemble attention modules and the ResNet blocks can be serialized N times (recommend with N=4 or 5) to build a more deeply attention network architecture.

3. The method of facial expression recognition according claim 1, further comprising:
In step 3, using combined two loss functions, which are ArcFace and Softmax, in training process of the model, The final loss function is the summation of two loss funtions with an alpha parameter as a weight of the combination, The formula is:
L_{final}=alpha*L_{ArcFace}+(1−alpha)*L_{Softmax}
In that, the alpha parameter is updated automatically based on a learning rate, In the earlier phase of training, while the learning rate is high (recommend with learning rate=0.01), alpha is set to a high value (e.g., alpha=0.9) to prioritize the ArcFace loss function and reduce overfiting, After the model is more stable, the alpha is gradually decreased to classify the facial expression based on Softmax loss, The deceasing of the learning rate is decided based on the accuracy on the validation dataset, If after 10 epochs, the accuracy on the validation dataset doesn't increase, the learning rate will be reduced to 1/10 of the earlier learning rate, The corresponding decreasing rate of alpha is decided based on the training experiment, and depending on the train dataset.
